(19) United States
(12) Patent Application Publication
(10) Pub. No.: US 2023/0008713 A1
(43) Pub. Date: Jan. 12, 2023

(54) MEDICAL DEVICE HAVING A LABEL AND METHOD FOR APPLYING A LABEL TO A MEDICAL DEVICE

(71) Applicant: FRESENIUS MEDICAL CARE DEUTSCHLAND GMBH, Bad Homburg (DE)

(72) Inventors: Jörn HOERMANN, St. Ingbert (DE); Sebastian MEISINGER, Marpingen (DE)

(73) Assignee: FRESENIUS MEDICAL CARE DEUTSCHLAND GMBH, Bad Homburg (DE)

(21) Appl. No.: 17/785,080

(22) PCT Filed: Dec. 16, 2020
(86) PCT No.: PCT/EP2020/086541

§ 371 Date: Jun. 14, 2022

(30) Foreign Application Priority Data
Dec. 16, 2019 (DE) 10 2019 134 562.6

(51) Int. Cl. G09F 3/00; A61J 1/10; B65C 9/00

(52) U.S. Cl. CPC G09F 3/0297; A61J 1/10; B65C 9/0015; A61J 2205/30; B65C 2009/0018

(57) ABSTRACT

The present invention relates to a medical device having a transparent region and a label wherein a hot stamping film is located on the transparent region; and a thermal transfer film that in turn has a label is located on the hot stamping film, with the label having a different color than the hot stamping film. The invention furthermore relates to a method of applying a label to a medical device.

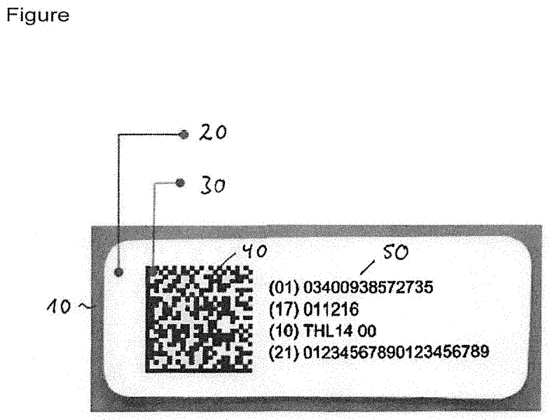

The present invention relates to a medical device having a transparent region and a label.

The EU required measures with directive 2011/62/EU to identify falsified medicinal products and to prevent the entry of falsified medicinal products into the delivery chains. Similar demands result for medical devices in accordance with the Medical Device Regulation Order (EU) 2017/745. A unique device identifier (UDI) is required as the label here. In this process, the printing of a film such as a bag is very demanding from a technical aspect and with respect to possible leachable ingredients (“leachables”).

It is therefore the object of the present invention to provide a medical device and a method in which a label adheres well, withstands a sterilization process, and is resistant to disinfectants. Apart from this, the strict demands for medicinal products with respect to extractables/leachables must be observed over the service life, etc.

This object is achieved by a medical device in accordance with claim 1 and by a method in accordance with claim 10.

Provision is accordingly made that a hot stamping film is located on the transparent region and that a thermal transfer film that in turn has a label is located on the hot stamping film, with the label having a different color than the hot stamping film.

In a preferred embodiment, the transparent region is itself a film, e.g. a bag film. The hot stamping film is applied thereto and finally the thermal transfer film is applied to said hot stamping film.

Said thermal transfer film consists of or at least comprises the label.

The transparent region is preferably a film.

In a further preferred embodiment, the medical device is a bag such as is used as part of a dialysis treatment. A bag is, for example, conceivable containing dialysis concentrate or dialysis solution or a medicinal product or a bag to receive consumed dialysis solution.

The label can, for example, be a code such as a barcode or a matrix code.

Alternatively or additionally, the label can be clear text information such as an article name.

Labeling with the aid of a code or of clear text can inter alia be an article name, batch information, date of manufacture or expiry date or a serial number, i.e. information is encoded or given in clear text. The printing process must therefore be able to print variable data.

To ensure sufficient contrast, the hot stamping film preferably has a lighter color than the thermal transfer film.

It is conceivable that the hot stamping film is white sectionally or overall and that the thermal transfer film is black sectionally or overall.

To ensure a sufficient service life of the label, the thermal transfer film can be configured to withstand a sterilization process of the medical device. It is preferably meant by this that the label withstands a temperature treatment at a temperature of 124° C. or more.

Further preferred properties of the label are its good adhesion to the transparent region such as on the bag, tubing, etc. and/or the resistance to disinfectants and/or that they have no extractables/leachables over their service life.

The medical device is preferably a bag that contains fresh or consumed dialysis solution or a dialysis concentrate or a medicament in solid or liquid form.

The present invention further relates to a method of manufacturing a medical device in accordance with one of the claims 1 to 9, wherein the hot stamping film is first applied to the transparent region in a hot stamping process, and wherein the thermal transfer film is applied to the hot stamping film in a further step.

It is pointed out at this point that the terms “a” and “one” do not necessarily refer to exactly one of the elements, even though this represents a possible embodiment, but can also designate a plurality of elements. The use of the plural equally also includes the presence of the element in question in the singular and, conversely, the singular also includes a plurality of the elements in question.

Further details and advantages will be explained in more detail with reference to an embodiment shown in the drawing.

The only FIGURE shows a hot stamping film located on a bag and having a label arranged thereon comprising a thermal transfer film.

The bag or the transparent film is marked by the reference numeral 10 in the FIGURE.

The hot stamping film 20, that is white, is located on this bag material.

The actual label is formed by a thermal transfer film 30 that is located on the hot stamping film.

The thermal transfer film comprises or consists of the label that in the embodiment is reproduced both as a code 40 and as a clear text label 50.

The serialization label (Data Matrix code +clear text information) has to be easily readable and a minimum quality is therefore required (grading according to ISO 15415); variable data furthermore have to be able to be printed (e.g. randomized serial numbers as the content of the code).

A high contrast is required to produce good readability and a black code is preferably printed on a white background for this reason.

Because the bag film is transparent, a white background is first applied to the bag for this purpose by the hot stamping process. The code and the clear text information are then printed in black using the thermal transfer process. This process makes it possible to print variable data.

The bag is preferably a bag containing a dialysis solution or a concentrate for a dialysis solution, a bag for receiving a consumed dialysis solution, etc.

1. A medical device having a transparent region and a label, characterized in that a hot stamping film is located on the transparent region; and in that a thermal transfer film that in turn has a label is located on the hot stamping film, with the label having a different color than the hot stamping film.

2. A medical device in accordance with claim 1, characterized in that the transparent region is a film.

3. A medical device in accordance with claim 1, characterized in that the medical device is a bag.

4. A medical device in accordance with claim 1, characterized in that the label is a code; or in that the label comprises a code.

5. A medical device in accordance with claim 1, characterized in that the label is a piece of clear text information; or in that the label comprises a piece of clear text information.

6. A medical device in accordance with claim 1, characterized in that the hot stamping film has a lighter color than the thermal transfer film and/or than the label.

7. A medical device in accordance with claim 1, characterized in that the label comprises a serialization information.

8. A medical device in accordance with claim 1, characterized in that the hot stamping film is white sectionally or overall; and in that the thermal transfer film or the label is black sectionally or overall.

9. A medical device in accordance with claim 1, characterized in that the thermal transfer film is configured to withstand a sterilization process of the medical device.

10. A medical device in accordance with claim 1, characterized in that the medical device is a bag.

11. A method of manufacturing a medical device in accordance with claim 1, characterized in that the hot stamping film is first applied to the transparent region of the medical device in a hot stamping process; and in that the thermal transfer film comprising or consisting of the label is applied to the hot stamping film in a further step.
